(19) United States
(12) Patent Application Publication
(10) Pub. No.: US 2023/0139847 A1
(43) Pub. Date: May 4, 2023

(54) REMOVING EXCESS BUILD MATERIALS

(71) Applicant: HEWLETT-PACKARD DEVELOPMENT COMPANY , L.P., Spring, TX (US)

(72) Inventors: Carlos SORROCHE CEREZALES, Sant cugat del Valles (ES); Arturo GARCIA GOMEZ, Sant cugat del Valles (ES)

(73) Assignee: HEWLETT-PACKARD DEVELOPMENT COMPANY , L.P., Spring, TX (US)

(21) Appl. No.: 17/514,423

(22) Filed: Oct. 29, 2021

(51) Int. Cl. B29C 64/35; B29C 64/245; B29C 64/393; B33Y 10/00; B33Y 30/00; B33Y 40/20; B33Y 50/02

(52) U.S. Cl. CPC B29C 64/35; B29C 64/245; B29C 64/393; B33Y 10/00; B33Y 30/00; B33Y 40/20; B33Y 50/02

(57) ABSTRACT

In an example, a method includes, by processing circuitry, receiving a parameter describing a build volume comprising an object generated using additive manufacturing and excess build material. In some examples the method further includes defining, by processing circuitry, an unpacking procedure for removing the excess build material from the object based on the received parameter.

### BACKGROUND

Additive manufacturing techniques may generate a three-dimensional object through the solidification of a build material, for example on a layer-by-layer basis. In examples of such techniques, build material may be supplied in a layer-wise manner and the solidification method may include heating the layers of build material to cause melting in selected regions. In other techniques, chemical solidification methods may be used. After the object is generated using additive manufacturing, excess build material may be separated from the object and in some examples the excess build material may be reused or recycled.

### BRIEF DESCRIPTION OF DRAWINGS

Non-limiting examples will now be described with reference to the accompanying drawings, in which:

FIG. 1 is a flowchart of an example of a method of defining an unpacking procedure for an unpacking apparatus;

FIG. 2 is a flowchart of an example of a method of unpacking an object generated using additive manufacturing;

FIGS. 3A to 3E are graphs showing example relationships between excess build material recovered and parameters describing a contents of a build volume;

FIG. 4 is a simplified schematic drawing of an example apparatus;

FIG. 5 is a simplified schematic drawing of an example apparatus comprising an unpacking apparatus; and

FIGS. 6 and 7 are simplified schematic drawings of an example machine-readable medium associated with a processor.

### DETAILED DESCRIPTION

Additive manufacturing techniques (also referred to as 3D printing) may generate a three-dimensional object through the solidification of a build material. In some examples, the build material is a powder-like granular material, which may for example be a plastic, ceramic or metal powder and the properties of generated objects may depend on the type of build material and the type of solidification mechanism used. Build material may be deposited, for example on a print bed and processed layer by layer, for example within a fabrication chamber. According to one example, a suitable build material may be PA12 build material commercially referred to as V1R10A “HP PA12” available from HP Inc.

In some examples, selective solidification is achieved through directional application of energy, for example using a laser or electron beam which results in solidification of build material where the directional energy is applied. In other examples, at least one print agent may be selectively applied to the build material and may be liquid when applied. For example, a fusing agent (also termed a ‘coalescence agent’ or ‘coalescing agent’) may be selectively distributed onto portions of a layer of build material in a pattern derived from data representing a slice of a three-dimensional object to be generated (which may for example be determined from structural design data). The fusing agent may have a composition which absorbs energy such that, when energy (for example, heat) is applied to the layer, the build material to which it has been applied heats up, coalesces and solidifies, upon cooling, to form a slice of the three-dimensional object in accordance with the pattern. In other examples, coalescence may be achieved in some other manner.

According to one example, a suitable fusing agent may be an ink-type formulation comprising carbon black, such as, for example, the fusing agent formulation commercially referred to as V1Q60A “HP fusing agent” available from HP Inc. Such a fusing agent may comprise any or any combination of an infra-red light absorber, a near infra-red light absorber, a visible light absorber, and a UV light absorber. Examples of fusing agents comprising visible light absorption enhancers are dye based colored ink and pigment based colored ink, such as inks commercially referred to as CE039A and CE042A available from HP Inc.

Although primarily described with reference to additive manufacturing apparatus which generate objects by solidification of a powder-like build material using fusing agent, other types of additive manufacturing apparatus may be used, for example a binder jet additive manufacturing apparatus, which generates an object by selectively depositing a binder material on successive layers of powder.

As noted above, additive manufacturing systems may generate objects based on structural design, or object model data. This may involve a designer designing a three-dimensional model of an object to be generated, for example using a computer aided design (CAD) application. The model may define the solid portions of the object. To generate a three-dimensional object from the model using an additive manufacturing system, the model data may comprise, or can be processed to derive, slices or parallel planes of the model. Each slice may define, using data, a portion of a respective layer of build material that is to be solidified or caused to coalesce by the additive manufacturing system.

Generating an object using additive manufacturing may comprise, in addition to the actual object generation, at least one pre-processing and/or post-processing operation. For example, prior to object generation, build material may be loaded into the additive manufacturing apparatus or loaded into a build unit of the additive manufacturing apparatus. A build unit may comprise several components of an additive manufacturing apparatus, such as the fabrication chamber, and may be removable from the additive manufacturing apparatus. Build materials may be loaded into the build unit at a build material processing apparatus, which may be an apparatus for handling and processing build material. For example, the build material processing apparatus may process used build material (i.e., build material which has been used in an additive manufacturing operation in a portion of a layer which was not caused to fuse, and thus remains in a powder or granular state, or may be processed to resume a powder or granular state) so that it is suitable for reuse and may mix such used or recycled build material and ‘fresh’ build material. The build material which is loaded into the additive manufacturing apparatus of the build unit may be fresh (i.e., previously unused) build material, used build material or a mixture of fresh and used build material.

When a build unit is used, the build unit may be loaded into the additive manufacturing apparatus prior to generating the object. The object may then be generated as described previously.

After the object has been generated, it may be allowed to cool, which may in some examples include actively cooling the object. In some examples, the build unit is removed from the additive manufacturing apparatus and the object is allowed to cool or is cooled within the fabrication chamber of the build unit. In other examples, the object and any excess build material is transferred to a cooling unit for cooling. This allows the build unit to be used to generate other object(s) without waiting for the previous object(s) to cool.

The cooling unit may be a natural cooling unit which allows the object to passively cool to room temperature. In other examples the cooling unit may comprise active cooling components, such as refrigeration components or fans. In some examples the contents of the fabrication chamber (i.e., the object and the excess build material) are transferred to the cooling unit using the build material processing apparatus.

When the contents of the build volume have cooled sufficiently, they may be unpacked. As used herein, unpacking describes the process of separating objects generated using additive manufacturing from excess build material. This may for example comprise using a vacuum pump to extract the excess build material, and/or separating build material from the object(s) using a sieve or the like. As described previously, objects may be surrounded by powdered build material when they are generated using additive manufacturing and to obtain the finished object, they are separated from the powdered build material. The powdered build material may adhere to the surface of the object or may form clumps which are to be broken up during the separation process.

When the powdered build material is separated from the object, the object may then be considered to be finished and may undergo no further processing, however in some examples further processing, such as sandblasting, may be used to provide a smoother finished surface on the object.

The separated build material may be recovered. The recovered build material, also referred to as used or recycled build material, may be reused to generate further objects or otherwise recycled. In some examples the build material undergoes further processing prior to reuse, for example to remove agents which may have been deposited in the build material or to ensure the particle size of the powder is suitable for reuse. For example, the used build material may be filtered to ensure uniform particle size (e.g., using a sieve) and the powder may undergo homogenization or vibration to avoid compaction or caking.

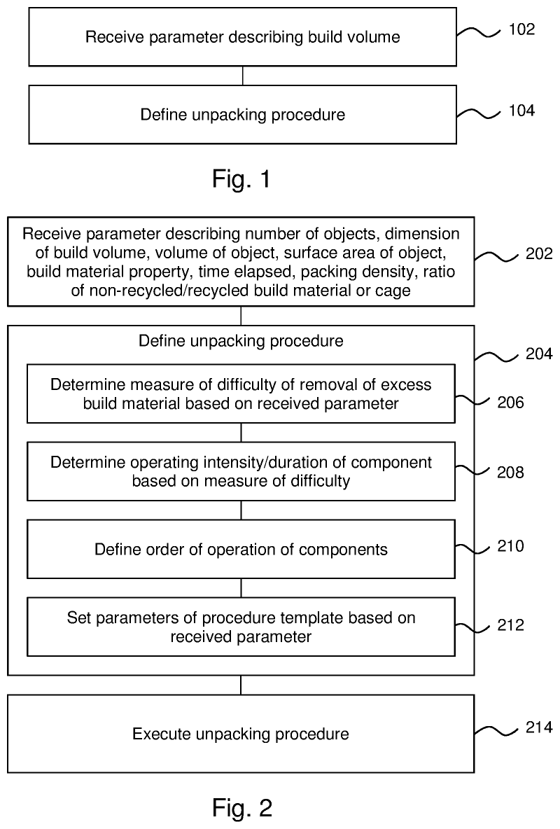

FIG. 1 is an example of a method, which may comprise a computer implemented method for defining an unpacking procedure for an unpacking apparatus for use in additive manufacturing processes. The blocks of the method may be performed using processing circuitry, which may in some examples comprise processing circuitry of an unpacking apparatus.

The method comprises, in block 102, receiving a parameter describing a build volume comprising an object generated using additive manufacturing and excess build material. The parameter may be received by processing circuitry from an apparatus associated with the build volume. For example, the parameter may be received from a storage device, wherein the storage device may be associated with the additive manufacturing apparatus used to generate the object, a build unit containing the object, or a cooling unit used to cool the object. In other examples, the parameter may be received over a network or the like.

In some examples the build volume may comprise multiple objects and the parameter may relate to multiple objects generated within the build volume.

The parameter may describe a physical characteristic of the contents of the build volume and/or the parameter may be a parameter which affects the unpacking of the build volume, for example it may describe any or any combination of: a number of objects in the build volume, a dimension of the build volume, a volume of the generated object(s), a surface area of the generated object(s), a property of the build material, a time elapsed since generation of the object(s), a packing density of objects in the build volume, and/or a quantity of excess build material in the build volume. In some examples, the parameter may be a parameter of the build material, such as build material type and/or a ratio of used to fresh build material. In some examples, the parameter may be a parameter which is indicative of the arrangement of the objects, for example if any object is enclosed by another object, for example if any object is enclosed by a ‘cage’ as described in greater detail below. In some examples the parameter may be a parameter which is a user specified characteristic, for example a user may specify a fragility parameter which specifies how susceptible to damage the object may be during the unpacking procedure, or may be a binary indication of whether the build volume comprises at least one fragile object or not, or the like. Additional examples of parameters are set out below.

The method comprises, in block 104, defining an unpacking procedure for removing the excess build material from the object based on the received parameter. An unpacking procedure may describe an action, or sequence of actions, which are performed to unpack the object(s). The actions may be included in instructions which are executable by an unpacking apparatus, wherein the unpacking apparatus comprises a component, or components, to assist in separating the generated object(s) and excess build material. The instructions may describe actions to be performed by the components of the unpacking apparatus. Defining the unpacking procedure may comprise defining which actions of a plurality of actions are to be performed and/or the parameters of such actions. As will be set out in greater detail below, examples of actions comprise the use of vibration and the use of gas jets to separate unsolidified build material from objects, and examples of the parameters comprise the intensity of vibration, the pressure of the gas jets, the duration of application of the vibration/jets and the like.

The unpacking procedure may for example be defined to reduce the cost, energy used and/or duration of the unpacking procedure, and/or may be defined to increase the proportion of excess build material recovered by the unpacking operation.

Defining the unpacking procedure may be based on measurements of build volumes comprising previously generated object(s) and measurements performed on said objects. For example, build volumes may be created containing a mixture objects and excess build material with different physical characteristics and the effectiveness of unpacking (e.g., proportion of build material recovered) may be measured to generate a model relating the parameters describing physical characteristics of the contents of the build volume to the actions of an unpacking procedure which provide effective unpacking for a build volume with those physical characteristics. In other examples, the unpacking procedures may be defined based on a theoretical analysis of which actions and action parameters are likely to be appropriate for a given build volume.

The contents of the build volume may be transferred from the additive manufacturing apparatus, the build unit, or the cooling unit to the unpacking apparatus. For example, the contents may be placed on a movable platform of the unpacking apparatus which supports the contents of the build volume and moves the contents to a volume within the unpacking apparatus. The actions described in the unpacking procedure may then be performed by the components of the unpacking apparatus to separate the object(s) and the excess build material. In other examples, the additive manufacturing apparatus, a build unit and/or a cooling unit may comprise unpacking apparatus.

The components of the unpacking apparatus may include any or any combination of the moveable platform, a gas jet and a vibrating element. In some examples the unpacking apparatus may comprise fewer or more components for separating the object(s) and the excess build material.

FIG. 2 provides an example of the method of FIG. 1. As discussed in greater detail below, blocks 202 and 204 may provide an example of the method of blocks 102 and 104 described in relation to FIG. 1.

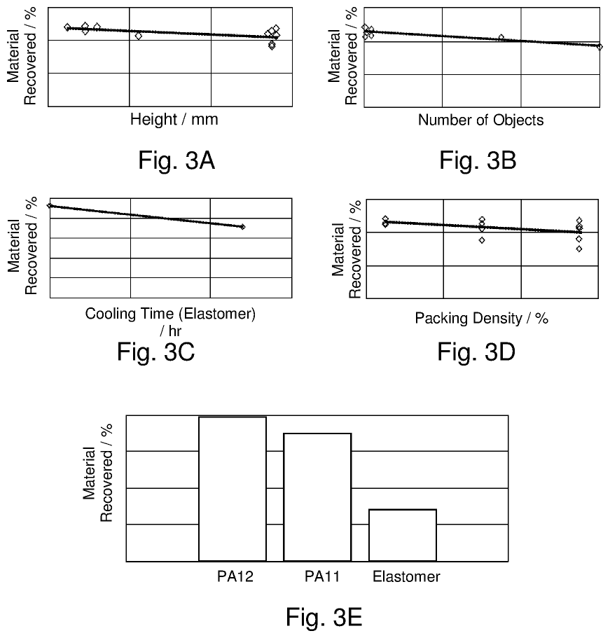

Block 202 comprises receiving a parameter describing a build volume comprising an object generated using additive manufacturing and excess build material, wherein the parameter describing the build volume describes at least one of: a number of objects in the build volume, a dimension of the build volume, a volume of the generated object(s), a surface area of the generated object(s), a property of the build material, a time elapsed since generation of the object, a packing density of objects in the build volume, ratio of non-recycled (i.e., new, fresh or not previously used or recycled) build material and recycled build material used and/or if the object(s) comprises a ‘cage’, and if so the cage type or a description of the cage (e.g., dimensions of the cage, dimensions of openings in the cage or dimensions of struts forming the cage). In some examples more than one of these parameters are received. The parameter(s) may be received by processing circuitry, for example processing circuitry of an unpacking apparatus. Example parameters are described in more detail in relation to FIGS. 3A to 3E.

A cage may also be referred to as a sintering box or a grid container, and may be a mesh or grid-like structure which surrounds and encloses a number of objects generated during additive manufacturing. The cage may comprise solidified portions of build material generated using additive manufacturing and a number of openings. A cage may be used to group a number of objects which are generated during additive manufacturing. For example, objects may be generated for different customers in a single additive manufacturing operation. The objects for a particular customer may be enclosed in a cage which allows them to be easily separated from objects for a different customer. The cage may be cut open or broken to access the objects therein.

The method comprises, in block 204, defining an unpacking procedure for removing the excess build material from the object based on the received parameter. Block 204 is an example of block 104 of FIG. 1. In this example defining the unpacking procedure comprises blocks 206 to 212.

Block 206 comprises determining a measure of difficulty of removal of the excess build material based on the received parameter. Determining how difficult it is to remove the excess build material may be based on the received parameter(s). For example, a difficulty score may be determined based on the parameter(s) or may be based on a combination of the parameters. The difficulty score may be an arbitrary scale or may correspond to some measurable property, for example it may be a measure of the expected proportion of build material remaining after a standardised unpacking procedure is performed on the contents of a build volume described by the parameter(s). In other examples difficulty categories may be assigned, for example high, medium, or low difficulty. For example, a large build volume with a small number of objects may be assigned a higher difficulty score or category than a smaller build volume with a smaller number of objects.

Block 208 comprises determining an operating intensity and/or duration of a component of an automated unpacking apparatus based on the measure of difficulty. In some examples, determining the operating intensity and/or duration of a component comprises defining, during the unpacking procedure, at least one of: an intensity and a duration of operation of a vibrating element to vibrate of the build volume, an intensity or duration of operation of a gas jet, and a motion of a platform supporting the build volume. When the difficulty of removal of the excess build material is determined to be relatively high, the component may be operated for a longer duration or a higher intensity, whereas when the difficulty is determined to be relatively low the component may be operated for a shorter duration and/or lower intensity. For example, the component may be a vibrating element or a gas jet, and such components may be operated for a longer duration when the difficulty is higher. When the component is a vibrating element the intensity of the vibration may be higher when the difficulty is determined to be higher. In this example, higher intensity vibrations may be vibrations of a larger displacement magnitude and/or higher oscillation speed or frequency. When the component is a gas jet, operating the component at a higher intensity may comprise operating the gas jet at a higher pressure and/or when the unpacking apparatus comprises multiple gas jets, operating at a higher intensity may comprise operating a larger number of gas jets. In some examples, the duration of the unpacking procedure as a whole may be determined (for example, the duration of operation of a vacuum pump to extract excess build material).

An unpacking apparatus may comprise a vibrating element which may be controlled to vibrate the contents of the build volume. For example, the vibrating element may comprise an oscillating element, for example powered by an electric motor or a piezoelectric element. In some examples the oscillating element is an electric motor with an eccentric mass which provides vibration when the motor causes the eccentric mass to rotate. In some examples the vibrating element vibrates by causing oscillations along one axis. In some examples multiple vibrating elements maybe used to cause oscillations along multiple axes or in some examples one vibrating element may cause oscillations along more than one axis. The intensity of vibration may refer to the magnitude of displacement caused by the vibrating element(s), the speed or acceleration caused by the vibrating element(s), the force applied by the vibrating element(s), the energy imparted by the vibrating element(s) or the number of axes of oscillation provided by the vibrating element(s). The vibrating element may for example act on the unpacking apparatus as a whole, or on a platform on which the content of the build volume is situated (e.g. the movable platform described below).

The unpacking apparatus may comprise a gas jet or multiple gas jets. The gas jet(s) may cause air, or another gas, to be forcefully moved to cause agitation of the build material. For example, the gas jet(s) may comprise a nozzle to cause pressurized gas to be ejected towards the contents of the build volume. In some examples the compressed gas is ejected with a pressure of 1 to 6 bar. Multiple gas jets may be arranged around the sides of the build volume. For example, more than one gas jet may be arranged along each side of the build volume. In some examples gas jets may be arranged at different heights along the sides of the build volume. In some examples the unpacking procedure may operate the gas jets independently, for example at different times or at different pressures. For example, gas jets on different sides of the build volume may be operated alternately or gas jets at different heights may be operated at different times. For example, gas jets near the top of the build volume may be operated early in the unpacking procedure and gas jets near the bottom of the build volume may be operated later in the unpacking procedure. In some examples the operation of the different gas jets may be determined based on the dimensions and/or position of the object(s) within the build volume. The pressure of the gas provided by the jets may be controllable, for example when it is determined that the build material is relatively difficult to remove or separate from the generated objects, the gas jet(s) may be operated at a higher pressure than when it is determined that the build material is relatively less difficult to remove.

The moveable platform may be controlled to raise or lower the contents of the build volume. For example, when loading the contents of the build volume prior to unpacking or to remove the object(s) after unpacking, the build platform may be lowered and raised respectively. In some examples the moveable platform may be moved during the unpacking procedure, for example the movable platform may be moved so that different regions within the build volume are exposed to the jets of gas provided by the gas jet(s).

In some examples. when the build volume has a relatively low height, the movable platform may be positioned in a partially raised position throughout the unpacking procedure and at least one gas jet may be located below the level of the moveable platform and therefore unable to direct pressurised gas towards the contents of the build volume. Therefore, in such examples a subset of gas jets may be operated, for example gas jet(s) located towards the top of the build volume. In other examples, when the build volume has a relatively larger height, all the gas jets may be capable of directing pressurised air towards the contents of the build volume and therefore all the jets may be used. In some examples the gas jets may be movable to direct pressurized gas towards different regions of the build volume. For example, the jets may be controlled to direct gas towards specific objects within the build volume. In some examples the moveable platform may be moved throughout the unpacking procedure, or the height of the movable platform varied at different times throughout the unpacking procedure to allow different regions of the build volume to be exposed to the jets of air provided by the gas jets. In some examples, the position of the movable platform varies throughout the unpacking procedure and the operation of the gas jets is based on the position of the moveable platform. For example, gas jets which are located above the moveable platform at any given time may be operated whereas gas jets which are located below the movable platform may not be operated at that time.

Block 210 comprises defining, during the unpacking procedure, an order of operation of at least two of: a vibrating element to vibrate the build volume, a gas jet, and a motion of a platform supporting the build volume. The unpacking procedure may define when, during the procedure, each of the components are operable. In some examples all components may operate throughout the procedure, whereas in other examples each component may operate throughout a portion of the procedure. In some examples each component may operate sequentially, whereas in other examples some components may operate at least partially concurrently. The order of operation may be determined based on the received parameter(s) and/or the determined measure of difficulty of removal of excess build material. For example, when it is determined that the build material is expected to be relatively difficult to remove, multiple cycles of vibration and application of air pressure using the gas jet(s) may be used. In some examples, the particular configuration of the build chamber may result in a particular sequence of operations being more effective at removing the excess build material. For example, a first type of build material may separate more readily when intense vibration is applied whereas a second type of build material may separate more readily when gas jets are used. Therefore, the procedure used for the first material may use a longer and/or more intense vibration and the procedure used for the second material may use longer and/or more intense application of the gas jets.

In another example, it may be determined that the object(s) are relatively fragile, and therefore may be damaged by intense vibration. Therefore, unpacking procedures for such object(s) may perform most of the excess build material removal using gas jets rather than vibration. In such examples, where the object(s) are determined to be relatively fragile, the speed or energy use of the unpacking procedure may be sacrificed to reduce damage caused to the object(s) during the procedure. For example, it may be determined that an object may be relatively fragile when the ratio of its surface area to volume is relatively high, as this may indicate a relatively convoluted or intricate surface. In other examples, a user may specify a fragility parameter which indicates how fragile the object(s) are considered to be (which may be binary indication of fragile or not fragile in some examples). For example, such parameters may be defined when sending a job describing the object(s) to be generated to the additive manufacturing apparatus.

Block 212 comprises setting parameters of a procedure template based on the received parameter. The method may comprise modifying or setting parameters of a predefined template. For example, the template may define a series of actions to perform to cause unpacking of the object(s). For example, the template may define the order of operation of the components of an unpacking apparatus and/or may define parameters comprising the duration and/or intensity of operation of the components. For example, the parameter may be a pressure of a gas jet, a flow rate of a gas jet (e.g., volume of gas per unit time, for example measured in standard cubic centimetres per minute (sccm)), intensity of vibration of a vibrating element (e.g., magnitude of displacement, number of axes of displacement, and/or speed of displacement) and/or duration of operation of the component. In some examples, setting the parameters may comprise changing at least one default parameter to a parameter determined based on the received parameter indicative of the build content.

In some examples, a user may specify an objective to be achieved by the unpacking operation and the unpacking procedure may be defined to achieve this objective. For example, a user may specify the unpacking procedure should prioritise recovering the most excess build material, reducing cost (e.g., by reducing energy usage), reducing the unpacking time or some other measure of effectiveness of the unpacking procedure. For example, a user may specify the unpacking produce should remove at least a threshold proportion of the build material in the shortest possible time or using the least energy. In some examples a user may further manually modify the unpacking procedure to satisfy some other condition.

In some examples defining the unpacking procedure may comprise calculating a property of the contents of the build volume based on the received parameters. For example, as mentioned above, the ratio of volume of the object(s) to the surface area of the object(s) may provide a measure of the intricacy or fragility of the objects). An unpacking procedure determined for objects which are determined to be more fragile may use less intense pressure applied by the gas jets and/or less intense vibration than would be used for object(s) which are determined to be less fragile. In other examples, other properties of the contents of the build volume may be determined by combining the received parameters, for example the ratio of the size of the objects (e.g., total volume or another dimension) to the number objects in the build volume may also affect the unpacking of the objects.

Block 214 comprises executing the unpacking procedure to separate the object(s) and the excess build material. Executing the unpacking procedure may comprise performing, by the unpacking apparatus, the actions defined in the unpacking procedure. For example, the unpacking apparatus may operate a moveable platform, gas jet(s) and/or vibrating element(s) for the duration, intensity and time defined in the unpacking procedure.

FIGS. 3A to 3E are a series of graphs which show examples of how the proportion of material recovered may vary as a function of characteristics of the build volume using default unpacking parameters in a default unpacking procedure which is common to all the examples. The proportion of build material which is recovered from a build volume provides an example of a measure of how effective the unpacking operation is. Therefore, the graphs shown in FIGS. 3A to 3E provide an indication of how difficult it is to separate the excess build material from the object(s) wherein a higher proportion of recovered build material indicates a more effective unpacking of object(s).

The dimensions of the build volume may affect the unpacking of objects. For example, FIG. 3A shows the relationship between the build material recovered and height of the build volume. As can be seen, the proportion of recovered build material decreases with increasing height. Without being bound by theory, this may be because a larger build volume may comprise a larger number of objects and/or quantity of build material, which therefore may be more difficult to unpack. Thus, according to the methods set out herein, various parameters may be set based on the height of the material in the build volume. For example, the moveable platform may therefore be controlled differently depending on the dimensions of the build volume, in particular based on the height of the build volume. The dimensions of the build volume may also affect the alignment of the objects and build material with the unpacking components of the unpacking apparatus. For example, components such as gas jets may function more efficiently when the object(s) are aligned with the jets, and such alignment may depend on the dimensions of the build volume. As the amount of material recovered decreases with increasing height of the build volume, when the received parameter indicates the height of the build volume is relatively large, the unpacking procedure may be defined to have a relatively longer duration or more intense operation of the unpacking components (e.g., higher pressure gas jets or more intense vibration). Conversely if the parameter indicates the build volume is relatively small the unpacking procedure may be defined to be relatively short with less intense operation of the unpacking components.

The number of objects in the build volume may affect the unpacking of the objects. For example, FIG. 3B shows the relationship between the build material recovered and the number of objects in the build volume and shows that the percentage of build material recovered is smaller when there is a larger number of objects. This may be because when there is a larger number of objects there are more spaces, or gaps, between the objects which may form ‘pockets’ of unsolidified build material. It may also be more difficult for the gas jets to provide jets of air throughout the build volume when there are more objects, for example the jets of air may be more likely to be partially obscured when there are more objects. Furthermore, a larger number of objects may form a barrier which partially blocks the path of the excess build material being removed and/or they may cause reduced vacuum efficiency of a vacuum pump which may be used to extract the build material. As the amount of material recovered decreases with increasing number of objects in the build volume, when the received parameter indicates the number of objects is relatively large, the unpacking procedure may be defined to have a relatively longer duration or more intense operation of the unpacking components. Conversely if the parameter indicates the number of objects is relatively small the unpacking procedure may be defined to be relatively short with less intense operation of the unpacking components.

The time elapsed between completion of generation of an object and unpacking of the object from the excess build material may be referred to as the cooling and may affect the unpacking of the objects. For example, FIG. 3C shows the relationship between the build material received and the cooling time for an elastomer material, for example TPA (thermoplastic polyamide) build material. For this material, longer cooling results in less build material being received. This may because the material may have a tendency to ‘cake’ during cooling, or for some other reason. As the amount of elastomer material recovered decreases with increasing cooling time, when the received parameter indicates the cooling time is relatively long, the unpacking procedure may be defined to have a relatively longer duration or more intense operation of the unpacking components. Conversely if the parameter indicates the cooling time is relatively short the unpacking procedure may be defined to be relatively short with less intense operation of the unpacking components. The relationship between the build material recovered and cooling time may be different for different types of material and the duration and intensity of operation of the unpacking components maybe defined accordingly.

The packing density of objects in the build volume may affect the unpacking. For example, FIG. 3D shows that the material recovered is lower for build volumes with a higher packing density. A larger number of objects may make it more difficult to extract the excess build material from the build volume. For example, a vacuum pump may be used to extract the build material and the higher packing density can create airflow barriers and reduce suction efficiency. Furthermore, an increased number and density of objects can obscure the airflow provided by the gas jets. As the amount of material recovered decreases with increasing packing density, when the received parameter indicates the packing density is relatively large, the unpacking procedure may be defined to have a relatively longer duration or more intense operation of the unpacking components. Conversely if the parameter indicates the packing density is relatively small the unpacking procedure may be defined to be relatively short with less intense operation of the unpacking components.

The type of build material may affect the unpacking. For example, FIG. 3E shows how the proportion of build material recovered varies with three different types of build material: PA12, PA11 and elastomer. Properties of the build material may affect how difficult it is to separate the excess build material and the object(s). For example, some build materials may have a greater tendency to adhere to surfaces of the object or to clump together. Therefore, the operation of the unpacking components may be varied based on the type of build material. For example, when the received parameter indicates the build material is a build material for which it is relatively difficult to recover used build material from (e.g., an elastomer such as TPA), the unpacking procedure may be defined to have a relatively longer duration or more intense operation of the unpacking components. Conversely if the parameter indicates the type of build material is a material such as PA12 the unpacking procedure may be defined to be relatively shorter with less intense operation of the unpacking components.

The surface area of the generated object(s) may affect the unpacking of objects. For example, it may be more difficult to remove excess build material from a larger surface area. Furthermore, a large surface area may be indicative of a highly textured or complex surface which may be more difficult to remove powder from.

In summary, the excess build material recovered may decrease, in some examples approximately linearly, with increasing parameters such as height of the build volume, number objects, cooling time and packing density. Therefore, defining the unpacking procedure, as described in block 104 of FIG. 1 and block 204 of FIG. 2 may comprise defining a target operating pressure, target operating vibration or target operating duration of at least one component and/or the unpacking procedure as a whole based on a linear relationship. The target operating pressure, vibration and duration may be defined according to the following equations:

Pressure target (Pₜ)=K_{P}×Nominal Pressure;

Vibration target (Vₜ)=K_{V}×Nominal Vibration; and

Duration target (Dₜ)=K_{D}×Nominal Duration,

wherein K_{P}, K_{V} and K_{D} are functions of the received parameter(s).

Other relationships may be determined in other examples.

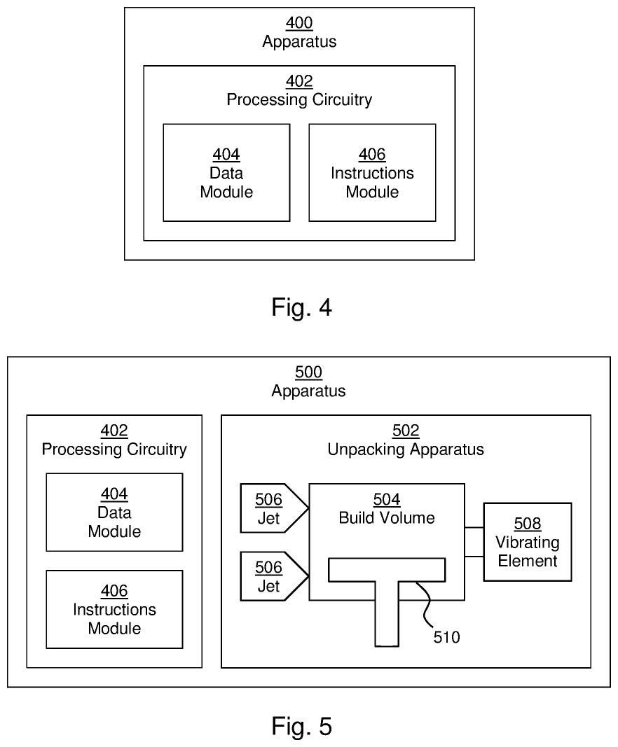

FIG. 4 shows an example of apparatus 400, which may be used in some unpacking operations, comprising processing circuitry 402. The processing circuitry 402 comprises a data module 404, and an instructions module 406. In some examples, the processing circuitry 402 may carry out any or any combination of blocks 102 to 104 of FIG. 1, or any combination of blocks 202 to 212 of FIG. 2.

In use of the apparatus 400, the data module 404 receives data describing a contents of a build volume of an additive manufacturing apparatus comprising at least one object generated in additive manufacturing. The build volume may further comprise excess build material. In order to obtain the generated object(s), the excess build material is separated from the object(s). The excess build material may be a powder material. The data describing the contents of the build volume may be data as described in block 102 of FIG. 1 or block 202 of FIG. 2, for example comprising at least one parameter describing a build volume comprising an object generated using additive manufacturing and excess build material, as set out above.

In some examples the apparatus 400 may comprise, be associated with, or be in communication with, an unpacking apparatus. In some examples, the apparatus 400 may communicate with the unpacking apparatus via a network or internet connection. In some examples the data received at the data module 404 may be received from the unpacking apparatus. For example, the unpacking apparatus may obtain data from a container, such as a build unit or cooling unit, holding the contents of the build volume prior to the contents of the build volume being loaded into the unpacking apparatus. For example, the contents of the build volume may be transferred from an additive manufacturing apparatus, a cooling unit or a build unit to the unpacking apparatus and a data storage means associated with the container may send the data to the data module 404 of the apparatus 400.

In use of the apparatus 400, the instructions module 406 creates instructions, executable by an unpacking apparatus, for separating unsolidified build material from the object(s) based on the received data. The instructions may define an unpacking procedure as described in block 104 of FIG. 1 or block 204 FIG. 2. In some examples the apparatus 400 may be associated with, or in communication with, an unpacking apparatus which may send the created instructions to the unpacking apparatus for execution.

FIG. 5 shows an example of an apparatus 500 comprising processing circuitry 402 which includes the data module 404 and the instructions module 406 of the apparatus 400 of FIG. 4. In addition, the apparatus 500 further comprises unpacking apparatus 502. In use of the apparatus 500, the unpacking apparatus 502 is to separate an object generated using additive manufacturing from excess build material in a build volume 504, for example according to instructions created by the instructions module 406.

The unpacking apparatus 502 may comprise a controllable unpacking component, or multiple unpacking components, and each unpacking component may be independently controllable according to the instructions. In this example the unpacking components of the unpacking apparatus 502 comprise gas jets 506, a vibrating element 508 and a movable platform 510 for supporting the contents of the build volume. However, in some examples the unpacking apparatus 502 may comprise further unpacking components, such as a vacuum pump, or a subset of the unpacking components described herein. Furthermore, in some examples, the number of each component may vary, for example the unpacking apparatus 502 may comprise fewer or more gas jets, vibrating elements and moveable platforms 510 than shown in FIG. 5. In this example the gas jets 506 are shown on the same side of the build volume, however in other examples the gas jets may be arranged on different sides of the build volume 504 or there may be multiple gas jets on each side of the build volume 504 or above and/or below the build volume 504. In this example, there are air jets 506 are arranged at different heights relative to the build volume 504. In some examples the gas jets 506 may be movably controllable to direct the pressurized gas in different directions.

In some examples the moveable platform 510 forms the base of the build volume 504. The moveable platform 510 may be controllable to load the build volume 504 comprising the object(s) and the excess build material and to control unloading of the object(s) after unpacking. The moveable platform 510 may also be controlled to move during unpacking, for example to raise and/or lower the object(s) and excess build material as the excess build material is separated from the object(s). For example, excess build material may be removed from the build volume 504 during unpacking and therefore the size of the contents of the build volume 504 may decrease during unpacking. Therefore, the moveable platform 510 may be raised to cause a corresponding reduction in the size of the build volume 504.

In this example the vibrating element is shown as being coupled to the side of the build volume 504 however in other examples the vibrating element may be coupled to the base of the build volume 504 or to the moveable platform 510. In some examples the vibrating element 508 is incorporated within the movable platform 510 to provide a vibrating moveable platform.

The unpacking apparatus may comprise further components, not shown in FIG. 5. For example, a portion of the build volume may be surrounded with a perforated material, such as a mesh, grid or material comprising a plurality of holes. This allows the excess build material to be removed from the build volume 504 when it has been separated from the objects. In examples where the moveable platform 510 forms the base of the build volume 504, the moveable platform may also comprise a mesh, grid, or a plurality of holes. For example, the build material may be a powder and the perforated material may act like a sieve, allowing the powder build material to pass through while trapping the object(s) in the build volume 502, thereby separating the excess build material from the object(s). Extraction of excess build material from the build volume 504 may further be assisted by use of a vacuum pump to reduce air pressure within the build volume 504 and suck out excess build material.

The unpacking apparatus 502 may further comprise collection and storing means for the excess build material. The excess build material may be processed for recycling or for reuse in a further additive manufacturing operation. The apparatus 500 may comprise build material reprocessing components or the collected excess build material may be transferred to a different apparatus for processing. In some examples the excess build material may be reused without any further processing, however in some examples the excess build material may be processed prior to reuse. For example, processing the build material for reuse may comprise passing the build material through a sieve to ensure uniformity of particle size and/or mixing with fresh build material. In some examples processing may further comprise vibrating the build material to reduce clumps or lumps of build material.

When the excess build material has been separated from the objects, the objects may then be ejected from the unpacking apparatus 502. For example, the moveable platform 510 may be raised to lift the object(s) out of the build volume 502 or a door in a side of the build volume may be opened to allow the object(s) to be removed.

In some examples the data module is to receive data by reading data from a data storage device associated with the build volume. In some examples the data module 404 comprises a wirelessly accessible data storage device reader, such as a RFID (Radio Frequency IDentification) tag reader and the data storage device associated with the build volume is a wirelessly accessible data storage device, such as a RFID tag. The contents of the build volume 504 may be transferred from the additive manufacturing apparatus to the unpacking apparatus 502 using a build unit or a cooling unit and the data storage device may be associated with the build unit or cooling unit. For example, the build unit or cooling unit may comprise a RFID tag and when the contents of the build volume 504 is being transferred from the build unit or the cooling unit to the unpacking apparatus, the RFID tag reader of the data module 404 may be in proximity of the RFID tag of the build unit or the cooling unit and may communicate with the RFID tag of the build unit or the cooling unit to obtain the data describing the contents of the build volume 504.

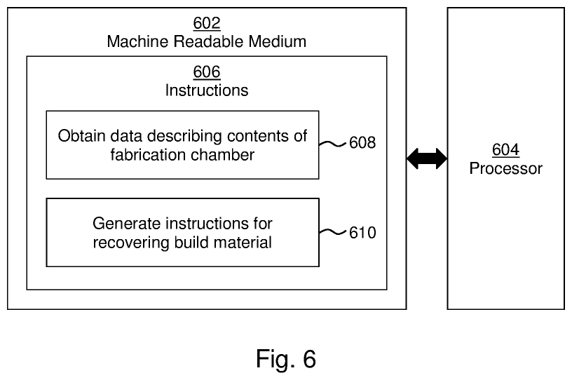

FIG. 6 shows a machine-readable medium 602 associated with a processor 604. The machine-readable medium 602 comprises instructions which, when executed by the processor 604, cause the processor 604 to carry out tasks.

In this example, the instructions 606 comprise instructions 608 to cause the processor 604 to obtain data describing a contents of a fabrication chamber comprising an object generated using additive manufacturing and surrounding build material. The data may be obtained as described in block 102 of FIG. 1 or block 202 of FIG. 2 or as described in relation to the data module 404 of FIGS. 4 and 5, and may for example comprise at least one parameter describing a build volume comprising an object generated using additive manufacturing and excess build material as described above.

In this example, the instructions 606 comprise instructions 610 to cause the processor 604 to generate instructions for recovering the build material from the build volume based on the obtained data. The generated instructions may comprise an unpacking procedure as described in relation to block 104 of FIG. 1 or block 204 of FIG. 2 or as described in relation to the instructions module 406 of FIGS. 4 and 5. The instructions may be executable by an apparatus such as the unpacking apparatus 502 described in relation to FIG. 5.

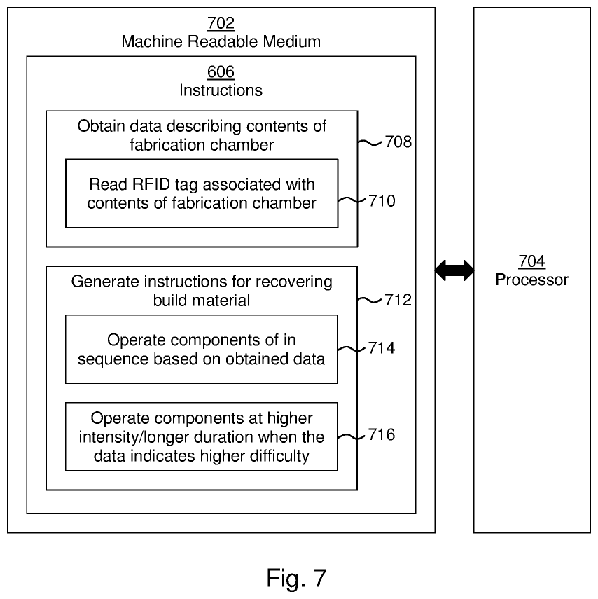

FIG. 7 shows a further example of a machine-readable medium 702 associated with a processor 704. The machine-readable medium 702 comprises instructions which, when executed by the processor 704, cause the processor 704 to carry out tasks.

In this example, the instructions 706 comprise instructions 708 to cause the processor 704 to obtain data describing a contents of a fabrication chamber comprising at least one object generated using additive manufacturing and surrounding build material, wherein the instructions 708 to obtain the data comprise instructions 710 to read an RFID tag associated with the contents of the fabrication chamber. The contents of the fabrication chamber may be transferred to the unpacking apparatus using a build unit or a cooling unit which comprises the RFID tag. In other examples the data may be stored in other data storage devices, such as other wirelessly accessible data storage devices and read by a corresponding wirelessly accessible data storage device reader.

In this example, the instructions 706 comprise instructions 710 to cause the processor 704 to generate instructions for recovering the build material from the build volume based on the obtained data, and may be an example of instructions 610 described in relation to FIG. 6. In this example the instructions 712 for recovering the build material comprise instructions 714 to operate components of an automated unpacking apparatus in a sequence, wherein the sequence of operation is based on the obtained data. Generating instructions to operate the components in a sequence based on the obtained data may be performed as described in relation to block 210 of FIG. 2.

The instructions for recovering build material further comprise instructions 716 to operate unpacking components at a higher intensity or longer duration when the obtained data indicates a higher difficulty of recovery of the build material. Generating instructions to operate the components with a particular duration or intensity may be performed as described in relation to block 208 of FIG. 2.

The generated instructions may be executable by an unpacking apparatus, for example the unpacking apparatus 502 described in relation to FIG. 5, to separate the object(s) from used build material.

Examples in the present disclosure can be provided as methods, systems or machine-readable instructions, such as any combination of software, hardware, firmware or the like. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow charts described above show a specific order of execution, the order of execution may differ from that which is depicted. Blocks described in relation to one flow chart may be combined with those of another flow chart. It shall be understood that each block in the flow charts and/or block diagrams, as well as combinations of the blocks in the flow charts and/or block diagrams can be realized by machine-readable instructions.

The machine-readable instructions may, for example, be executed by a general purpose computer, a special purpose computer, an embedded processor or processors of other programmable data processing devices to realize the functions described in the description and diagrams. In particular, a processor or processing apparatus may execute the machine-readable instructions. Thus, functional modules (e.g., the data module 404 and/or the instructions module 406) of the apparatus and devices may be implemented by a processor executing machine-readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine-readable instructions may also be stored in a computer readable storage that can guide the computer or other programmable data processing devices to operate in a specific mode.

Such machine-readable instructions may also be loaded onto a computer or other programmable data processing devices, so that the computer or other programmable data processing devices perform a series of operations to produce computer-implemented processing, thus the instructions executed on the computer or other programmable devices realize functions specified by block(s) in the flow charts and/or block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus, and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising, by processing circuitry:
receiving a parameter describing a build volume comprising an object generated using additive manufacturing and excess build material; and
defining an unpacking procedure for removing the excess build material from the object based on the received parameter.

2. A method as claimed in claim 1 wherein defining the unpacking procedure comprises defining, during the unpacking procedure, at least one of:
an intensity and/or a duration of operation of a vibrating element to vibrate of the build volume;
an intensity and/or a duration of operation of a gas jet;
a motion of a platform supporting the build volume; and
a duration of the unpacking procedure.

3. A method as claimed in claim 1, wherein defining the unpacking procedure comprises defining, during the unpacking procedure, an order of operation of at least two of:
a vibrating element to vibrate the build volume;
a gas jet; and
a motion of a platform supporting the build volume.

4. A method as claimed in claim 1, wherein defining the unpacking procedure comprises:
determining a measure of difficulty of removal of the excess build material based on the received parameter; and
determining an operating intensity and/or duration of at least one component of an automated unpacking apparatus based on the measure of difficulty.

5. A method as claimed in claim 1, wherein defining the unpacking procedure comprises setting parameters of a procedure template based on the received parameter.

6. A method as claimed in claim 1, wherein the parameter describing the build volume describes;
a surface area of the generated object.

7. A method as claimed in claim 1, further comprising:
executing the unpacking procedure to separate the object and the excess build material.

8. An apparatus comprising processing circuitry, the processing circuitry comprising:
a data module to receive data describing contents of a build volume of an additive manufacturing apparatus comprising an object generated in additive manufacturing; and
an instructions module to create instructions, executable by an unpacking apparatus, for separating unsolidified build material from the object based on the received data.

9. An apparatus as claimed in claim 8, further comprising the unpacking apparatus, wherein the unpacking apparatus comprises at least one of:
a vibrating element;
a gas jet; and
a movable platform for supporting the contents of the build volume.

10. An apparatus as claimed in claim 8, wherein the apparatus comprises a plurality of controllable unpacking components and each unpacking component is independently controllable according to the instructions.

11. An apparatus as claimed in claim 8, wherein the data module is to receive data by reading data from a data storage device associated with the build volume.

12. A machine-readable medium comprising machine-readable instructions, which when executed by a processor, cause the processor to:
obtain data describing a contents of a fabrication chamber comprising an object generated using additive manufacturing and surrounding build material; and
generate instructions for recovering the build material from the build volume based on the obtained data.

13. A machine-readable as claimed in claim 12, wherein the instructions for recovering the build material comprise instructions to operate components of an automated unpacking apparatus in a sequence, wherein the sequence of operation is based on the obtained data.

14. A machine-readable medium as claimed in claim 12, wherein the instructions comprise instructions to operate unpacking components at at least one of a higher intensity and a longer duration when the obtained data indicates a higher difficulty of recovery of the build material.

15. A machine-readable medium as claimed in claim 12, wherein the instructions to obtain the data comprise instructions to read an RFID tag associated with the contents of the fabrication chamber.

16. The method of claim 2, wherein defining the unpacking procedure further comprises defining a vacuum level of a vacuum pump.

17. The method of claim 1, further comprising defining a fragility parameter for the object generated using additive manufacturing and excess build material.

18. The method of claim 7, wherein the fragility parameter is a user-specified parameter specifying how susceptible to damage the object may be during the unpacking procedure.

19. The method of claim 7, wherein the fragility parameter is a binary indication of whether the object is fragile.

20. The method of claim 1, further comprising defining a difficulty score for removal of excess build material.

21. The method of claim 20, wherein the difficulty score is based on a received parameter.

22. The method of claim 20, wherein the difficulty score is a measure of an expected proportion of build material remaining after the unpacking procedure.
